(19) United States
(12) Patent Application Publication
(10) Pub. No.: US 2023/0331611 A1
(43) Pub. Date: Oct. 19, 2023

(54) METHOD OF VISIBLE-LIGHT PHOTOCATALYSIS COMBINED WITH CLO2 OXIDATION FOR HIGHLY EFFICIENT REMOVAL OF ORGANIC POLLUTANTS IN WASTEWATER

(71) Applicant: SHAN DONG UNIVERSITY, Qingdao (CN)

(72) Inventors: Qian LI, Qingdao (CN); Ruidian SU, Qingdao (CN); Yuan SU, Qingdao (CN)

(21) Appl. No.: 17/781,551

(22) PCT Filed: Aug. 19, 2020
(86) PCT No.: PCT/CN2020/109989

§ 371 Date: Jun. 1, 2022

(30) Foreign Application Priority Data
May 20, 2020 (CN) 202010430301.3

(51) Int. Cl. C02F 9/00; B01J 23/50; B01J 21/06; B01J 23/22; B01J 27/24; B01J 35/00

(52) U.S. Cl. CPC C02F 9/00; B01J 23/50; B01J 21/063; B01J 23/22; B01J 27/24; B01J 35/004; C02F 2101/38

(57) ABSTRACT

A method of visible-light photocatalysis combined with ClO₂ oxidation for high efficient removal of organic pollutants in the wastewater, includes that i) the pH of the organic wastewater is adjusted to a constant value; the visible light photocatalysts are added to wastewater with full stirring to reach the adsorption equilibrium; (ii) turning on the Xenon lamp and adjust the distance between the light source and the liquid surface; chlorite is added to the system to reach a concentration and the reaction remained at a constant temperature with adequate stirring to achieve the degradation of organic pollutants.

### TECHNICAL FIELD

The present invention is related to a method of visible-light photocatalysis combined with ClO₂ oxidation for highly efficient removal of organic pollutants in wastewater and belongs to the field of chemical and environmental technology of organic wastewater treatment.

### BACKGROUND ART

With the growth of industrial development and the improvement of living and working conditions, organic wastewater gradually poses a threat to ecological safety and human health. At present, in addition to traditional wastewater treatment techniques (such as adsorption, coagulation, and membrane filtration), the application of advanced oxidation techniques (such as photocatalysis and ClO₂ oxidation) on organic contaminant degradation become a research hotspot. Photocatalytic oxidation technique utilizes semiconductors as catalysts and sunlight as driving energy to generate oxidizing active species (such as hydroxyl radicals, superoxide radicals, etc.), converting organic pollutants into non-toxic or low-toxic intermediates, which is a strong-oxidizing, energy-saving, efficient and thorough technique to remove contaminants. Now, photocatalytic oxidation techniques represented by the visible light photocatalytic technique are mostly applied in wastewater treatment processes such as industrial organic wastewater and antibiotic pharmaceutical wastewater. However, due to the high efficiency of electron-hole recombination and the low efficiency of photon utilization, the photocatalytic efficiency cannot reach the theoretical value in the application of the traditional photocatalytic technique. In addition, in photocatalytic oxidation, the active species with short life are prone to be quenched during mass transfer, and the oxidative degradation of contaminants is also restricted to the solid-liquid interface, which restricts the improvement of pollutant removal efficiency and the large-scale industrial application of photocatalytic technique.

Despite the combination of photocatalytic technique and other techniques to treat wastewater (such as the photocatalytic-adsorption flocculation combination technology for refractory organic wastewater disclosed in the Chinese patent CN105016526A), the problems of short life and easy-quenching of photogenerated active species have not been solved, so the removal efficiency of contaminants has not been effectively improved.

In addition to photocatalytic oxidation technology, ClO₂ oxidation, as a common effluent disinfection technology, is widely used in water treatment processes (such as medical wastewater oxidation treatment, and drinking water disinfection) because ClO₂ has the advantages of strong oxidation, long durability, high efficiency, and less disinfection by-product formation. In the traditional production of ClO₂, the precursor chlorite is converted into ClO₂ by ozone oxidation, strong acidification, strong ultraviolet oxidation, etc. But the transformation efficiency of chlorite is relatively low and there are risks of bringing chlorite into the effluent. At the same time, due to the restriction standards proposed by many countries and organizations for the concentration of chlorite in water, the inorganic disinfection by-products (such as chlorite and chlorate) produced by ClO₂ oxidation have become a potential risk to human health. Therefore, ClO₂ oxidation technology is in a dilemma between the improvement of the oxidative efficiency of contaminants and the reduction of risks of disinfection by-products.

Given the disadvantages of low utilization efficiency of protons and short lifetime of active species in photocatalytic technique and the disadvantages of complex operation, high energy consumption, and difficult elimination of inorganic disinfection by-products in ClO₂ oxidation, it is urgent to propose a novel technology for green, efficient, energy-saving, and environmentally friendly organic wastewater treatment.

Contents of Invention

Given the existing disadvantages of photocatalytic technology and ClO₂ oxidation technology, this invention proposed a method of visible-light photocatalysis combined with ClO₂ oxidation for the highly efficient removal of organic pollutants in wastewater.

Overview of Invention:

In the present invention, the oxidative removal of organic contaminants was carried out in a quartz reactor with a double-walled cooling circulating water interlayer. The visible light photocatalysis—ClO₂ oxidation combined system was constructed with visible light photocatalyst as catalysts, chlorine-containing salts as the precursor of ClO₂, and a xenon lamp with a certain optical power density as the light source, to achieve efficient removal of organic contaminants in wastewater.

### DESCRIPTION OF THE INVENTION

The present invention is implemented by the following technical proposal:

The step of a method of visible-light photocatalysis combined with ClO₂ oxidation for highly efficient removal of organic pollutants in wastewater is as follows:

(1) The wastewater containing organic contaminants was adjusted to a constant pH. Then, the visible light photocatalysts were added into the solution in dark followed by full stirring until the adsorption equilibrium;

(2) Adjust the distance between the light source and the surface of the wastewater after turning on the Xenon lamp and the chlorite was added into the system with the constant temperature and full stirring to achieve the degradation of organic pollutants.

Optimized according to the invention, in step (1), the pH is 3-11 adjusted by an acidic regulator or an alkaline regulator.

Further optimized, in step (1), the pH is 5-9.

Further optimized, the acidic regulator is hydrochloric acid, acetic acid, or nitric acid and the alkaline regulator is NaOH or ammonium hydroxide.

Optimized according to the invention, in step (1), the visible light photocatalyst is one of Ag/TiO₂, BiVO₄, and C₃N₄.

Further optimized, the visible light photocatalyst is BiVO₄.

Optimized according to the invention, in step (1), the dosage of visible light photocatalysts is 10-50 mg/L.

Optimized according to the invention, in step (1), the organic pollutants in wastewater are one or two mixtures of norfloxacin, sulfadiazine, bisphenol A and imidacloprid.

Optimized according to the invention, in step (1), the wastewater is tap water, surface water, domestic sewage, printing and dyeing wastewater, medical wastewater, or seawater.

Optimized according to the invention, in step (2), the optical power density of the light source is 100-300 mW/cm²′ and the distance between the light source and the surface of the wastewater is 10-50 cm.

Optimized according to the invention, in step (2), the chlorine-containing salt is one of hypochlorite, chlorite, chlorate, or perchlorate.

Optimized according to the invention, in step (2), the concentration of chlorine-containing salts is 0.1-1.0 mmol/L.

Optimized according to the invention, in step (2), the stirring time is 30-60 min.

Optimized according to the invention, in step (2), the reaction temperature is 25-45° C.

The treatment process in the present invention is not affected by inorganic and organic matters. In the presence of inorganic and organic matters, the present invention still has a high processing efficiency, so the treatment process of the present invention is more stable.

Compared to the prior art, the beneficial effects of the present invention are:

1. The present invention employs a visible light photocatalysis-ClO₂ oxidation process to remove organic contaminants in wastewater. The photogenerated active species serve as oxidants to transfer electrons to chlorine-containing salts to generate reactive chlorine species (such as ClO₂). The reactive chlorine species are oxidative and durable, which are capable of continuous oxidative degradation of organic contaminants, avoiding the problems of a short lifetime and short mass transfer distance of photogenerated active species and improving the efficiency of contaminant degradation. In addition, ClO₂ prefers selectively attacking compounds containing structures such as phenol and aniline, resulting in further degradation of contaminants that cannot be completely degraded by photocatalysis, which is conducive to increasing the mineralization rate and reducing biological toxicity.

2. In the treatment process in the present invention, photogenerated active species serve as oxidants to oxidize chlorine-containing salts to produce reactive chlorine species such as ClO₂. This avoids the utilization of strong oxidants, strong acids, or strong lights in the traditional production of ClO₂ and reduces the raw material costs and the production risks, which is conducive to the safe and orderly proceeding of the actual water treatment process.

3. In the treatment process in the present invention, ClO₂ was produced by adding solid chlorine-containing salts into a photocatalytic system, which is a safe, easy to operate, and controllable way to achieve simultaneous ClO₂ production with photocatalysis. This greatly reduces the cost of production, storage, and off-site transportation in traditional ClO₂ production, reduces the potential risks in the entire production process, and enhances the safety and controllability of the reaction.

4. In the treatment process in the present invention, the dosage of chlorine-containing salts was much lower than the dosage of chlorine-containing substances in current industrial ClO₂ oxidation techniques, which meet the limit criteria for the concentration of chlorine-containing ions. In addition, after the oxidation of contaminants, ClO₂ was partially converted to chlorine-containing ions, which participate in a new ClO₂ conversion process. This improves the utilization efficiency of ClO₂ and prolongs the catalytic lifetime of the visible light photocatalysis-ClO₂ oxidation combined system.

5. In the treatment process in the present invention, the photocatalysts respond well to visible light, which can utilize sunlight more efficiently as compared with UV light. It provides the possibility of degradation of organic contaminants by sunlight-driven photocatalytic technology and reduces energy consumption.

6. The treatment process in the present invention is not affected by inorganic and organic matters. In the presence of inorganic and organic matters, the present invention still has a high processing efficiency, so the treatment process of the present invention is more stable.

### BRIEF DESCRIPTION OF THE FIGURES

FIG. 1 shows a schematic diagram of the double-walled reactor with an interlayer;

In FIG. 1, 1—light source, 2—sealing lid, 3—gas outlet, 4—liquid inlet, 5—sample outlet, 6—cooling water inlet, 7—gas inlet, 8—cooling water outlet, 9—wastewater, 10—catalyst.

FIG. 2 shows the comparison of the performance of visible light photocatalysis-ClO₂ oxidation combined process mediated by different visible light photocatalysts in the treatment of norfloxacin organic wastewater as described in the embodiments 1-3 of the present invention.

FIG. 3 shows the performance of visible light photocatalysis-ClO₂ oxidation combined process composed of different concentrations of chlorine-containing precursors in the treatment of norfloxacin organic wastewater.

FIG. 4 shows the effect of pH on the performance of visible light photocatalysis-ClO₂ oxidation combined process in the treatment of norfloxacin organic wastewater as described in the embodiments 7 of the present invention.

FIG. 5 shows the effect of inorganic and organic substances on the performance of visible light photocatalysis-ClO₂ oxidation combined process in the treatment of norfloxacin organic wastewater as described in the embodiments 8-12 of the present invention.

FIG. 6 shows the effect of actual water matrices on the performance of visible light photocatalysis-ClO₂ oxidation combined process in the treatment of norfloxacin organic wastewater as described in the embodiments 13-18 of the present invention.

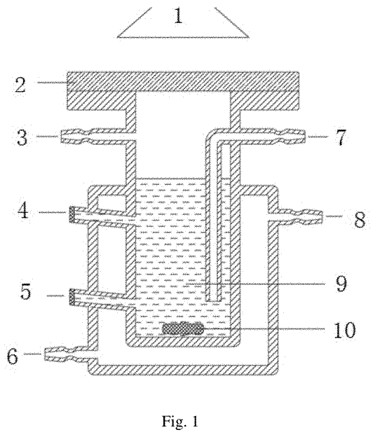

### DETAILED EMBODIMENTS

The present invention is further described by the specific embodiments and figures, but the protection scope of the present invention is not limited to the following embodiments.

Unless otherwise specified, the raw materials used in the embodiment are conventional commercial products.

The double-walled reactor with an interlayer in embodiments is composed of a reactor body with a reaction cavity enclosed by an inner wall and an interlayer between the inner wall and outer wall. There are air inlet and outlet on the inner wall and the air inlet is connected to the intake pipe, which extends to the bottom of the reaction cavity. There are liquid inlet and sample outlet on the inner wall, which separately pass through the outer wall. There are cooling water inlet and outlet on the outer wall, which connect with the interlayer. There is a sealing lid at the opening of the inner wall.

### Embodiment 1

The steps of a method of visible-light photocatalysis combined with ClO₂ oxidation for highly efficient removal of organic pollutants in wastewater are as follows:

(1) The pH of organic wastewater containing organic contaminants was adjusted to 7. Then, 30 mg of visible light photocatalyst BiVO₄ was added into the wastewater and stirred for 60 min until the adsorption equilibrium;

(2) Turn on the Xenon lamp and adjust the distance between the light source and liquid surface by 30 cm. Sodium hypochlorite, as the precursor of ClO₂, was added to the system to reach a concentration of 1.0 mmol/L with a constant reaction temperature and full stirring to achieve the degradation of contaminants.

### Embodiment 2

Similar to the method of visible-light photocatalysis combined with ClO₂ oxidation for highly efficient removal of organic pollutants in the wastewater as described in embodiment 1, the difference is that the visible light photocatalyst was selected as Ag/TiO₂ and the other information was the same as Embodiment 1.

### Embodiment 3

Similar to the method of visible-light photocatalysis combined with ClO₂ oxidation for highly efficient removal of organic pollutants in the wastewater as described in embodiment 1, the difference is that the visible light photocatalyst was selected as C₃N₄ and the other information was the same as Embodiment 1.

### Embodiment 4

Similar to the method of visible-light photocatalysis combined with ClO₂ oxidation for highly efficient removal of organic pollutants in the wastewater as described in embodiment 1, the difference is that the precursor of ClO₂ was selected as sodium chlorite and the other information was the same as Embodiment 1.

### Embodiment 5

Similar to the method of visible-light photocatalysis combined with ClO₂ oxidation for highly efficient removal of organic pollutants in the wastewater as described in embodiment 1, the difference is that the precursor of ClO₂ was selected as sodium chlorate and the other information was the same as Embodiment 1.

### Embodiment 6

Similar to the method of visible-light photocatalysis combined with ClO₂ oxidation for highly efficient removal of organic pollutants in the wastewater as described in embodiment 1, the difference is that the precursor of ClO₂ was selected as sodium perchlorate and the other information was the same as Embodiment 1.

### Embodiment 7

Similar to the method of visible-light photocatalysis combined with ClO₂ oxidation for highly efficient removal of organic pollutants in the wastewater as described in embodiment 1, the difference is that the pH of wastewater was adjusted to 3, 5, 7, 9, 11 before adding BiVO₄ photocatalysts and the other information was the same as Embodiment 1.

### Embodiment 8

Similar to the method of visible-light photocatalysis combined with ClO₂ oxidation for highly efficient removal of organic pollutants in the wastewater as described in embodiment 1, the difference is that 10.0 mmol/L of Cl⁻ was dosed into the solution at the same time as adding the precursor of ClO₂ and the other information was the same as Embodiment 1.

### Embodiment 9

Similar to the method of visible-light photocatalysis combined with ClO₂ oxidation for highly efficient removal of organic pollutants in the wastewater as described in embodiment 1, the difference is that 10.0 mmol/L of SO₄²⁻ was dosed into the solution at the same time as adding the precursor of ClO₂ and the other information was the same as Embodiment 1.

### Embodiment 10

Similar to the method of visible-light photocatalysis combined with ClO₂ oxidation for highly efficient removal of organic pollutants in the wastewater as described in embodiment 1, the difference is that 10.0 mmol/L of HCO₃⁻ was dosed into the solution at the same time as adding the precursor of ClO₂ and the other information was the same as Embodiment 1.

### Embodiment 11

Similar to the method of visible-light photocatalysis combined with ClO₂ oxidation for highly efficient removal of organic pollutants in the wastewater as described in embodiment 1, the difference is that 1.0 mmol/L of ClO₃⁻ was dosed into the solution at the same time as adding the precursor of ClO₂ and the other information was the same as Embodiment 1.

### Embodiment 12

Similar to the method of visible-light photocatalysis combined with ClO₂ oxidation for highly efficient removal of organic pollutants in the wastewater as described in embodiment 1, the difference is that 1.0 mg/L of fulvic acid was dosed into the solution at the same time as adding the precursor of ClO₂ and the other information was the same as Embodiment 1.

### Experimental Examples for Application

The degradation experiments of simulated norfloxacin wastewater were carried out in a double-walled reactor with an interlayer. The initial concentration of norfloxacin in the simulated wastewater is 10 mg/L and the initial volume is 100 mL. The temperature of the reactor was maintained at 25° C. by feeding a thermostatic cooling circulating water to the interlayer of the double-walled reactor. At the same time, the control group without hypochlorite was established. During the degradation of norfloxacin, 1 mL of sample was collected at a certain interval, i.e. 0 min, 5 min, 10 min, 15 min, 30 min, 45 min, 60 min, 90 min, and 120 min, and filtered through a 0.22 μm membrane to further detect the concentration change of norfloxacin by high-performance liquid chromatography.

### Experimental Example 1

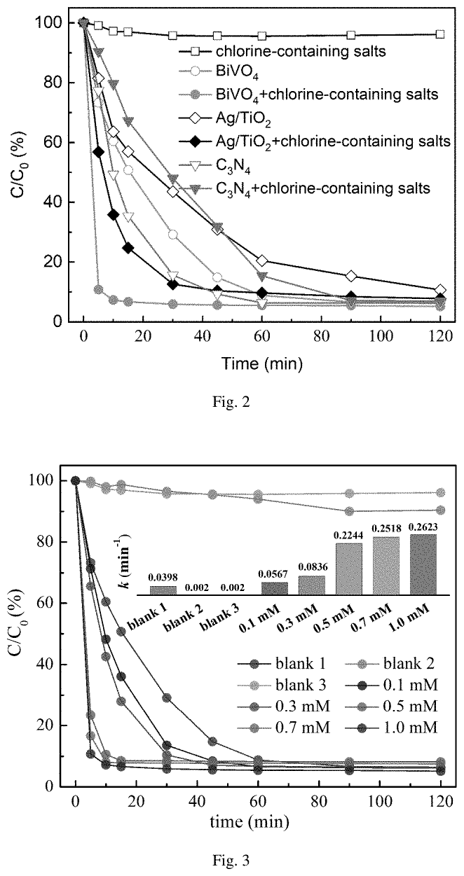

The performance of visible light photocatalysis-ClO₂ oxidation combined process mediated by different visible light photocatalysts to treat norfloxacin organic wastewater was shown in FIG. 2.

### Experimental Example 2

The performance of visible light photocatalysis-ClO₂ oxidation combined process composed of different concentrations of chlorine-containing precursors to treat norfloxacin organic wastewater was shown in FIG. 3.

### Experimental Example 3

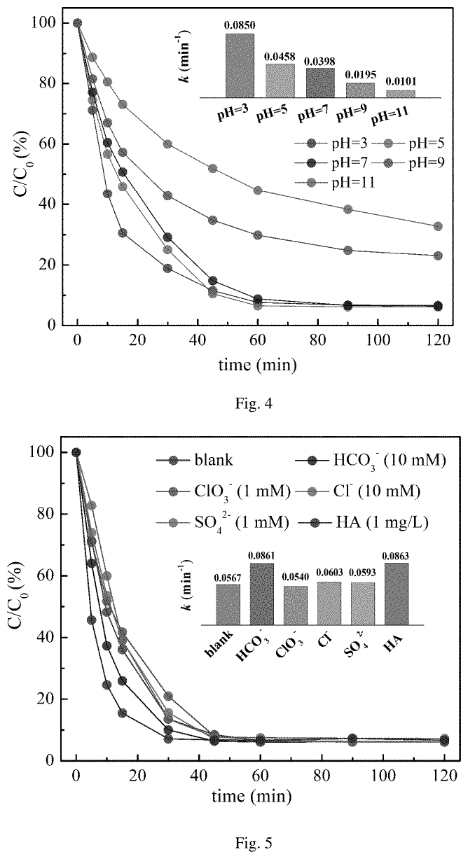

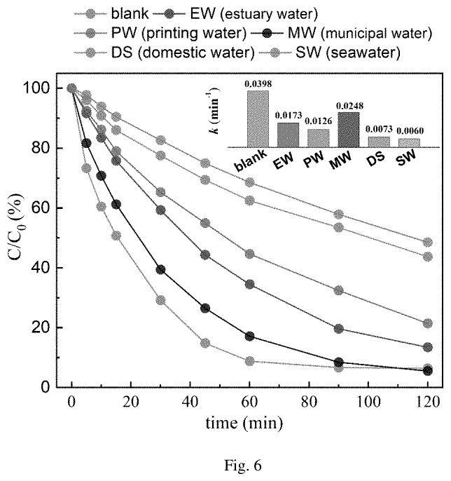

The effect of pH on the performance of visible light photocatalysis-ClO₂ oxidation combined process to treat norfloxacin organic wastewater was shown in FIG. 4.

### Experimental Example 4

Moreover, in this invention, the single factor experiments on the effect of inorganic and organic matters on the performance of visible light photocatalysis-ClO₂ oxidation combined process to treat norfloxacin organic wastewater was carried out. And the ability of degradation and anti-interference of this process in actual water matrix was investigated. After reaching the adsorption equilibrium, a certain concentration of interfering matters was added to the organic wastewater including inorganic and organic matters. Meanwhile, a certain concentration of chlorine-containing salts was added into the same reactor with full stirring for contaminant degradation and the reaction temperature was controlled by the cooling water. The inorganic matters are one or more than two mixtures of Cl⁻, Br⁻, ClO₃⁻, NO₃⁻, SO₄²⁻, CO₃²⁻ or HCO₃⁻ with a concentration of 0.01-0.10 mmol/L. The organic matters are one or two mixtures of fulvic acid, brown humic acid, or humic acid.

### Embodiment 13

Similar to the method of visible-light photocatalysis combined with ClO₂ oxidation for highly efficient removal of organic pollutants in the wastewater as described in embodiment 1, the difference is that the organic solution was prepared using tap water and the other information was the same as Embodiment 1.

### Embodiment 14

Similar to the method of visible-light photocatalysis combined with ClO₂ oxidation for highly efficient removal of organic pollutants in the wastewater as described in embodiment 1, the difference is that the organic solution was prepared using surface water and the other information was the same as Embodiment 1.

### Embodiment 15

Similar to the method of visible-light photocatalysis combined with ClO₂ oxidation for highly efficient removal of organic pollutants in the wastewater as described in embodiment 1, the difference is that the organic solution was prepared using medical wastewater and the other information was the same as Embodiment 1.

### Embodiment 16

Similar to the method of visible-light photocatalysis combined with ClO₂ oxidation for highly efficient removal of organic pollutants in the wastewater as described in embodiment 1, the difference is that the organic solution was prepared using domestic sewage and the other information was the same as Embodiment 1.

### Embodiment 17

Similar to the method of visible-light photocatalysis combined with ClO₂ oxidation for highly efficient removal of organic pollutants in the wastewater as described in embodiment 1, the difference is that the organic solution was prepared using printing wastewater and the other information was the same as Embodiment 1.

### Embodiment 18

Similar to the method of visible-light photocatalysis combined with ClO₂ oxidation for highly efficient removal of organic pollutants in the wastewater as described in embodiment 1, the difference is that the organic solution was prepared using seawater and the other information was the same as Embodiment 1.

What is claimed is:

1. A method of visible-light photocatalysis combined with ClO₂ oxidation for high efficient removal of organic pollutants in wastewater comprising the following steps:
i) adjusting the pH of the wastewater to a constant value;
ii) adding the visible light photocatalysts to the wastewater which is stirred in dark for 60 min until adsorption reached equilibrium;
iii) turning on a Xenon lamp and adjusting the distance between a light source and a liquid surface; and
iv) adding a chlorine-containing salt to reach a certain concentration and keeping reaction at a constant temperature with adequate stirring to achieve the degradation of the organic pollutants.

2. The method according to claim 1, characterized in that, adjusting the pH by an acidic regulator or an alkaline regulator in pH 3-11 which is optionally pH 5-9.

3. The method according to claim 2, characterized in that, the acid regulator is selected from the group consisting of hydrochloric acid, acetic acid, or nitric acid, and the alkaline regulators are NaOH and ammonium hydroxide.

4. The method according to claim 1, characterized in that, the visible light photocatalyst is selected from the group consisting of Ag/TiO₂, BiVO₄, and C₃N₄; and is optionally BiVO₄.

5. The method according to claim 1, characterized in that, the concentration of the visible light photocatalysts is 10-50 mg/L.

6. The method according to claim 1, characterized in that, the organic pollutants are one or more than two selected from the group consisting of norfloxacin, sulfadiazine, bisphenol A and imidacloprid; and the wastewater is selected from the group consisting of tap water, surface water, domestic sewage, printing & dyeing wastewater, medical wastewater, and seawater.

7. The method according to claim 1, characterized in that, the optical power density of the light source is 100-300 mW/cm² and the distance between the light source and the surface of the wastewater is 10-50 cm.

8. The method according to claim 1, characterized in that, the chlorine-containing salt is selected from the group consisting of hypochlorites, chlorites, chlorates and perchlorates.

9. The method according to claim 1, characterized in that, the concentration of the chlorine-containing salt is 0.1-1.0 mmol/L.

10. The method according to claim 1, characterized in that, in the step iv), a stirring time is 30-60 min and the constant temperature is 25-45° C.
